(19) United States
(12) Patent Application Publication
(10) Pub. No.: US 2026/0064975 A1
(43) Pub. Date: Mar. 5, 2026

(54) DEVICE AND METHOD FOR EXTRACTING WORDS THAT A CHILD NEEDS TO LEARN BY PROFILING THE CHILD'S CONVERSATION(AL) CONTENT

(71) Applicants: POSTECH RESEARCH AND BUSINESS DEVELOPMENT FOUNDATION, Pohang (KR); EWHA UNIVERSITY-INDUSTRY COLLABORATION FOUNDATION, Seoul (KR)

(72) Inventors: Inseok Hwang, Pohang (KR); Jungeun Lee, Pohang (KR); Suwon Yoon, Pohang (KR); Kyoosik Lee, Pohang (KR); Wonjeong Park, Seoul (KR); Dongsun Yim, Seoul (KR)

(73) Assignees: POSTECH RESEARCH AND BUSINESS DEVELOPMENT FOUNDATION, Pohangi (KR); EWHA UNIVERSITY-INDUSTRY COLLABORATION FOUNDATION, Seoul (KR)

(21) Appl. No.: 19/186,640

(22) Filed: Apr. 23, 2025

(30) Foreign Application Priority Data
Aug. 30, 2024 (KR) 10-2024-0117641
Dec. 10, 2024 (KR) 10-2024-0182284

(51) Int. Cl. G06F 40/35; G06F 40/279

(52) U.S. Cl. CPC G06F 40/35; G06F 40/279

(57) ABSTRACT

According to the present invention, a device for extracting learning words (vocabulary) comprises: a memory storing a learning-word extraction program that extracts learning words to be taught to or learned by a child based on a conversation(al) content of the child; and a processor that executes the learning-word extraction program, wherein the learning-word extraction program receives conversation data, extracts a first word set uttered by a non-child and a second word set uttered by the child from the conversation data, generates a third word set by excluding the second word set from the first word set, and selects learning words to be taught to the child from the third word set based on selection criteria.

### TECHNICAL FIELD

The present invention relates to a device and method for extracting words that a child needs to learn by profiling the child's conversation(al) context.

### BACKGROUND ART

This section merely provides background information for the embodiments of the present invention and is not construed as prior art.

All children are different, and the language environment in which each child lives is also different. A child's language environments is formed according to the culture and period in which the child lives, the people with whom the child frequently interact, and the socioeconomic status of the child's family. This language environment of the child is the most basic linguistic element, and it affects the type and range of vocabulary that the child encounters in daily interactions, and has a great influence on the child's subsequent language development.

Vocabulary skill for a young child is recognized as a very good indicator of academic achievement, and vocabulary assessment results are recognized as a measure of potential language delay, which, if not assessed and intervened in a timely manner, can lead to learning disabilities, mental illness, or low socioeconomic status.

It is important to assess vocabulary skills early. And standardized instruments for assessing language skills for children (e.g., M-B CDI, PPVT) define a scoring system consisting of a small number of standard words that are sampled from large-scale language studies. However, standardized instruments have several limitations.

The cost of modifying these standard words (set) is very high, and the modification cycle is long. In some cases, they remain unchanged for more than 10 years. In addition, it is very difficult for standardized tools to accommodate temporal changes in language. For example, a tool produced in 2007 does not include the word “smartphone”, which is used everywhere today. And, most importantly, personalization is difficult.

Children's daily language environments are diverse, and the informal vocabulary each child naturally acquires is very different. Nevertheless, standardized tools are inadequate for assessing individual child's actual language skill in a personalized manner, because they assess children's skills with a fixed set of words.

Therefore, a technology and technique is required to intervene and assess children's vocabulary skills based on each child's actual language skills.

### SUMMARY OF INVENTION

### Technical Problem

An object of the present invention is to provide a learning word extraction device and method that extracts words for a child to learn from words that the child did not speak, based on the child's conversation data.

Objects of the present invention are not limited to the one mentioned above, and other objects and advantages of the present invention that are not mentioned herein may be understood by the description below, and as they will be more clearly understood by the embodiments of the present invention. In addition, it will be easily understood that the objects and advantages of the present invention may be realized by the means and combinations thereof, as indicated in the claims.

### Technical Solutions

According to an embodiment of the present invention, a learning word extraction device may comprise: a memory that stores a learning word extraction program that extracts learning words to be taught to a child based on the child's conversation content, and a processor that executes the learning word extraction program; wherein the learning word extraction program receives a conversation data, extracts a first word set uttered by the non-child and a second word set uttered by the child from the conversation data, generates a third word set by excluding the second word set from the first word set, and selects the learning words to be taught to the child from the third word set, based on a selection criteria.

Also, the learning word extraction program may calculate a word-level parameter for each word included in the first word set, and calculate a priority score based on the word-level parameter; wherein the word level parameter may include at least one of a frequency indicating the number of times a/the word appears, a commonality indicating how many contexts a/the word commonly appears in, and a perceptual salience indicating how clearly a/the word is pronounced.

Also, the learning word extraction program may calculate the priority score for each word by adjusting a weight for each word-level parameter by performing a linear regression algorithm based on a weight criteria.

Also, the learning word extraction program may extract common words that are simultaneously included in (both) the first word set and the second word set, and calculate the priority score for the first word set by adjusting the weights for the word-level parameters of the words through the linear regression algorithm so that the common words in the first word set are calculated to have a higher priority score than that of (the) other words.

Also, the learning word extraction program may extract common words that are simultaneously included in the first word set and the second word set, and adjust the weight for each word-level parameter through the linear regression algorithm so that words having a high similarity to the common words in the first word set are calculated to have a higher priority score than that of other words and then calculate the priority score for the first word set.

Also, the learning word extraction program may calculate usability for each word included in the first word set, and calculate the priority score for the first word set while adjusting the weight for each word-level parameter through the linear regression algorithm so that a word that has a predetermined frequency or lower than the predetermined frequency but a relatively higher usability, is calculated to have a higher priority score than that of other words; wherein the usability may indicate how many words can be as replacements in a context.

Also, the learning word extraction program may generate the third word set by excluding the second word set from the first word set, and select n-number of words with the highest priority score from the third word set as the learning words.

In addition, the learning word extraction program may receive a filtering signal for filtering words to be excluded from the third word set, and select the n-number of words from the third word set as the learning words based on the filtering signal.

Also, the learning word extraction program may divide the third word set based on parts of speech, and extract at least one word from each part of speech group to select as the learning word.

Also, the learning word extraction program may generate and provide a story that contains the learning word so that the learning word may be learned.

Also, the learning word extraction program may summarize a reference story that is included in a story dataset into m-number of sentences, and generate a story for learning based on the m-number of sentences, the learning words, and a story generation criteria.

According to an embodiment of the present invention, a learning word extraction method may comprise: a step of receiving conversation data; a step of extracting a first word set uttered by a non-child and a second word set uttered by a child, from the conversation data; a step of generating a third word set, by excluding the second word set from the first word set; and a step of selecting learning words to be taught to the child from the third word set, based on a selection criteria included in the third word set.

Also, the step of generating the third word set may comprise: calculating a word-level parameter for each word included in the first word set, and calculating a priority score based on the word-level parameter; wherein the word-level parameter may include at least one of a frequency indicating a number of times a word appears, a commonality indicating how many different contexts a word commonly appears in, and a perceptual salience indicating how clearly a word is pronounced.

Also, the step of generating the third word set may comprise calculating the priority score for each word by adjusting a weight for each word-level parameter, by performing a linear regression algorithm based on a weight criteria.

Also, the step of generating the third word set may comprise: extracting common words simultaneously included in the first word set and the second word set, and calculating the priority score for the first word set by adjusting the weights for the word-level parameters of the words through the linear regression algorithm so that the common words in the first word set are calculated to have a higher priority score than that of other words.

Also, the step of generating the third word set may comprise: extracting common words included in both the first word set and the second word set, and calculating the priority score for the first word set by adjusting the weight for each word-level parameter through the linear regression algorithm so that a word having a high similarity to the common word in the first word set is calculated to have a higher priority score than that of the other words.

Also, the step of generating the third word set may comprise: calculating the usability for each word included in the first word set, and calculating the priority score for the first word set by adjusting the weight for each word-level parameter through the linear regression algorithm so that a word having a predetermined frequency or lower than the predetermined frequency while having relatively higher usability is calculated to have a higher priority score than that of other words; wherein the usability indicates how many words a given word may be used to replace them in a given context.

Also, the step of selecting the learning words may comprise selecting n-number of words having the highest priority scores from the third word set as the learning words.

Also, the step of selecting the learning words may include a learning word extraction method that receives a filtering signal for filtering words to be excluded from the third word set, and selects the n-number of words from the third word set as the learning words based on the filtering signal.

Also, the step of selecting the learning words may comprise: dividing the third word set based on parts of speech, extracting at least one word from each part-of-speech group, and selecting the at least one word as the learning words.

Also, the learning word extraction method may further comprise a step of generating a story that contains the learning words so that the learning words may be learned.

Also, the step of generating the story that contains the learning words may comprise: summarizing a reference story which is included in a story dataset into m-number of sentences, and generating a learning story or a story for learning, based on the m-number of sentences, the learning words, and a story generation criteria.

### Advantageous Effects

The learning word extraction device and method of the present invention may extract vocabulary words necessary for a child's language development from/through an actual language environment, and thereby increase the accuracy of evaluating the child's language development.

In addition, compared to the situation where it is difficult to teach vocabulary words necessary for language development using existing toys or storybooks, the necessary vocabulary words may be provided by creating a storybook and thereby facilitating vocabulary learning.

In addition to the above, detailed effects of the present invention are described while explaining specifics for carrying out the invention below.

### BRIEF DESCRIPTION OF THE DRAWINGS

FIG. 1 is a conceptual diagram schematically illustrating a learning-word extraction device according to an embodiment of the present invention.

FIG. 2 is a block diagram schematically illustrating a configuration of a learning-word extraction device according to an embodiment of the present invention.

FIG. 3-FIG. 7 are exemplary diagrams for describing operations of a learning-word extraction device according to embodiments of the present invention.

FIG. 8 is a flowchart for describing a learning-word extraction method according to an embodiment of the present invention.

FIG. 9 is a flowchart for describing a process of extracting learning words illustrated in FIG. 8.

FIG. 10 is a flowchart for describing a process of generating a learning story illustrated in FIG. 8.

### DETAILED DESCRIPTION OF INVENTION

Terms or words used in the present specification and claims should not be limited to and interpreted as having ordinary meanings or dictionary definitions. In accordance with the principle that the inventor can define the terms or words in order to explain his or her invention in the best way, they should be interpreted with a meaning and concept consistent with the technical spirit and scope of the present invention. Additionally, embodiments described in this specification and the configurations shown in the drawings are merely embodiments of the present invention and do not represent the technical spirit and scope of the present invention in its entirety. Thus, it should be understood that there may be various equivalents, modifications, and other examples that may be applied, that can replace the embodiments at the time of filing the present application.

Terms such as “first (1^{st}),” “second (2^{nd})” A, B, etc. used in the present specification and claims may be used to describe various elements and/or parts but the elements and/or parts should not be limited by these terms. These terms are used only to distinguish one element and/or part from another. For instance, a first element may be termed a second element and vice versa, without departing from the scope of the present invention. Term(s) “and/or” may include any one or a plurality of related elements or items described.

Terms used in the present specification and claims are used for the purpose of describing particular exemplary embodiments only and are not intended to limit the present invention. Singular terms or forms include the plural forms as well, unless the context clearly indicates otherwise. The terms or language “comprising,” “including,” “having,” etc. are intended to indicate the presence of described features, numbers, steps, operations, components, elements, and/or combination thereof, as described in the present specification, and should not be understood as precluding the presence or addition of one or more of other features, numbers, steps, operations, components, elements, and/or combination thereof.

Unless otherwise defined, all terms (including technical and scientific terms) used herein have same meaning as those commonly understood by a person with ordinary skill in the art to which this invention pertains.

Terms, such as those defined in commonly used dictionaries, should be interpreted as having meaning that is consistent with their meaning in the context of the relevant art and should not be interpreted in an idealized or overly formal sense, unless expressly, so defined herein.

Additionally, each configuration, process, manufacturing process, or method, etc. included in each embodiment of the present invention may be shared when not contradictory to each other in technical sense.

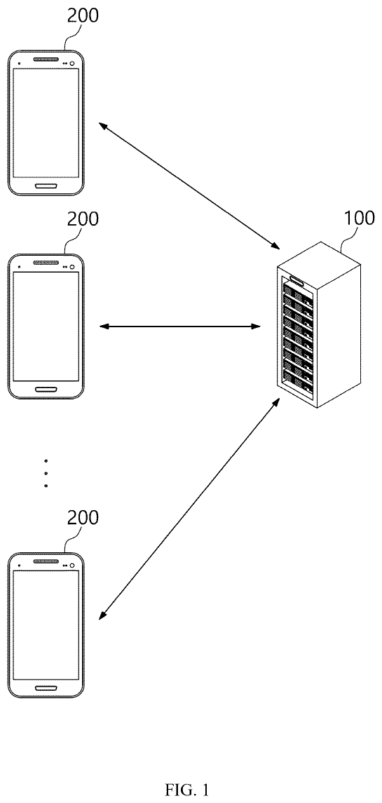

Hereafter, described in detail are a device and method for extracting learning words (or vocabulary words to learn), according to embodiments of the present invention, by referencing FIG. 1 through FIG. 10.

First, the learning-words extraction device is described with reference to FIG. 1 through FIG. 7.

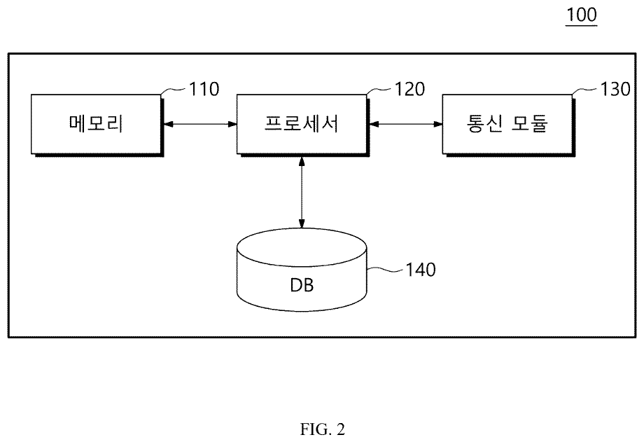

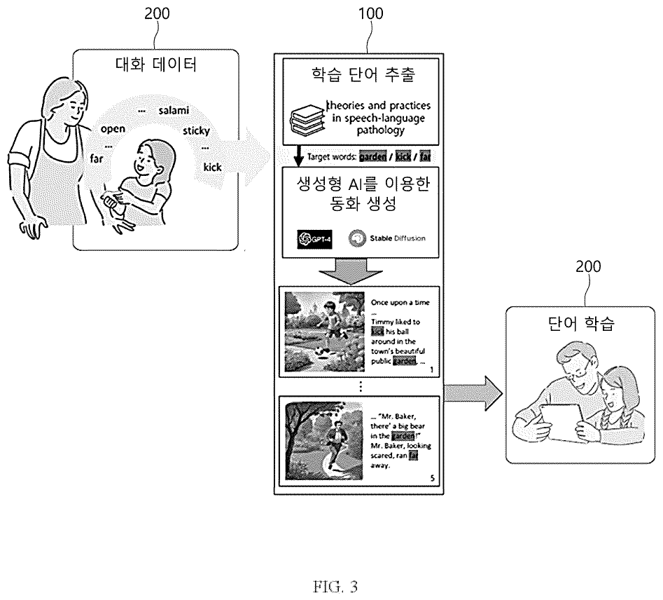

FIG. 1 is a conceptual diagram schematically illustrating a learning-word extraction device according to an embodiment of the present invention. FIG. 2 is a block diagram schematically illustrating a configuration of a learning-word extraction device according to an embodiment of the present invention. FIG. 3 through FIG. 7 are exemplary diagrams for describing operations of a learning-word extraction device according to an embodiment of the present invention.

Referencing FIG. 1 through FIG. 3, a learning-word extraction device (100) receives a child's conversation data recorded through at least one of a first recorder (10) or a second recorder (20) from a user terminal (200), and extracts a first word set uttered by a non-child and a second word set uttered by a/the child from the conversation data.

Afterward, the second word set uttered by the child is excluded from the first word set uttered by the non-child, thereby generating a third word set not uttered by the child; and learning words to be taught to the child or learned by the child may be selected from the third word set based on a selection criteria or conditions.

Then, in order to teach the extracted learning words to the child, a story (e.g., fairy tale) containing the learning words may be created and provided to the user terminal (200).

Here, the child's conversation data may be conversation(al) content between the child and a caregiver such as a parent. Based on this, the first word set may represent words spoken by the caregiver, and the second word set may represent words spoken by the child. And, the learning words may be words included in the conversation data that the child has not learned—that is, words that the child does not know.

In addition, the first recorder (10) may be a type of recorder, such as a necklace or watch, that may be worn by the child or the caregiver and may record the voice of the child or the caregiver from a closer distance and clearly record the voice of the child or caregiver even when the child and caregiver are conversing while moving. The second recorder (20) may be a recorder fixed to a predetermined location and may record an entire conversation. The conversation data can include a first conversation data recorded by the first recorder (10) and a second conversation data recorded by the second recorder (20). In the first conversation data, the child's or caregiver's speech or utterance may primarily be recorded, and in the second conversation data, the conversation between the child and caregiver may primarily be recorded.

In order to perform such operation, the learning-word extraction device (100) may include a memory (110) and a processor (120).

The memory (110) may store a learning-word extraction program that extracts the learning words, which are words that the child has not learned, from among a plurality of words included in the conversation data. The memory (110) may be interpreted as a general term for a nonvolatile storage device that continues to maintain stored information even when power is not supplied thereto and for a volatile storage device that requires power to maintain stored information. In addition, the memory (110) may perform a function of temporarily or permanently storing data processed by the processor (120). The memory (110) may include a nonvolatile storage device such as a magnetic storage media or a flash storage media in addition to a volatile storage device that requires power to maintain stored information, but the scope of the present invention is not limited thereto.

The processor (120) may execute a learning-word extraction program stored in the memory (110) to extract words unknown to the child that the child has not learned from the conversation and provide them as the learning words. Referencing FIG. 3, an operation of the learning-word extraction program is briefly described: the operation may be performed to receive the conversation data from the user terminal (200), extract the learning words to be learned by the child from the conversation data, and create a learning story (or the story that contains the learning words) using the learning words to have the child to learn the words, and provide it to the user terminal (200).

To more specifically describe the operation of the learning-word extraction program extracting the learning words, the first word set uttered by the non-child and the second word set uttered by the child may be differentiated and distinguished in the conversation data, and the second word set uttered by the child may be excluded from the first word set uttered by the non-child to generate a third word set not uttered by the child. Thereafter, the learning words to be taught to the child may be selected from the third word set based on a word level parameter set for each word in the third word set.

Then, the learning-word extraction program may generate a/the story using the learning words and provide it to the user terminal (200), to have the child learn the words.

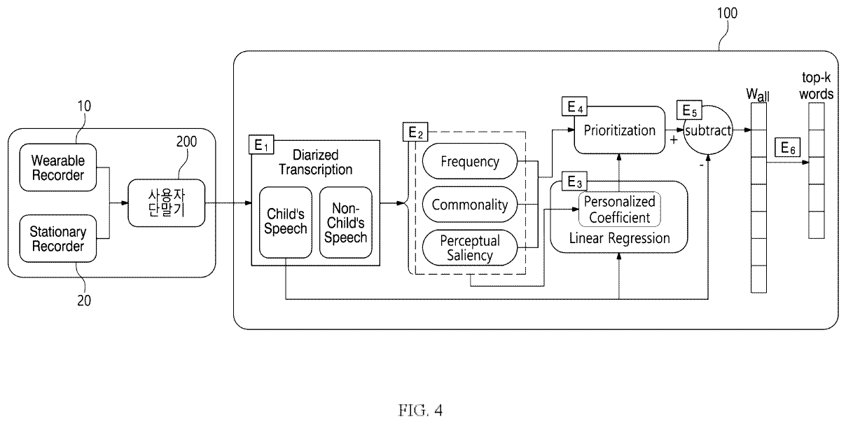

FIG. 4 through FIG. 7 are exemplary diagrams for describing operations of the learning word extraction program of the present invention. The operation of the learning-word extraction program are more specifically described with reference to FIG. 4 to FIG. 7.

FIG. 4 is an exemplary diagram for describing the operation of the learning-word extraction program extracting learning words. Referencing FIG. 4, the learning-word extraction program may extract the learning words by performing Steps E1 through E6.

First, an operation of generating the first word set and the second word set (Step E1) is described. In Step E1, the learning-word extraction program converts the conversation data in voice format received from the user terminal (200) into a conversation script to distinguish between the non-child speaker and the child speaker. Then, based on the conversation script, the first word set, which is the words spoken by the non-child speaker, and the second word set, which is the words spoken by the child speaker, may be generated.

In the process of generating the first word set and the second word set, the learning-word extraction program may remove stop words, which are words that cannot be used. In the process of removing the stop words, tags for the part-of-speech of each word may be set, and stop words may be selected based on the part-of-speech tags. In addition, if there are multiple identical roots with different suffixes, the learning-word extraction program may perform an operation of keeping only one and removing the rest.

Here, the non-child speaker may be a caregiver such as the parent. That is, the conversation data may be data recorded from a conversation between a child and a parent. In addition, the conversation data may include the first conversation data recorded by a first recorder (10) that the child may wear and the second conversation data recorded by the second recorder (20) that is fixed at a predetermined location. The first recorder (10) may be a recorder of the type that may be worn by the child or the caregiver, such as a necklace or watch, and may record the voice of the child or caregiver with more details at a closer distance, and may clearly record the voice of the child or caregiver even when the child and caregiver are conversing while moving. The second recorder (20), as the recorder fixed at a predetermined location, may record the entire conversation between the child and the parent.

Next, an operation of calculating word level parameters for each word included in the first word set (Step E2) is described.

The learning-word extraction program may calculate the word level parameters of each word included in the first word set, based on the conversation data. The word level parameters may include at least one of frequency, commonality, and perceptual salience. Frequency may be a numerical representation of the number of times a word appears in the conversation data. Commonality may be a numerical representation of how many contexts a word commonly appears in. And Perceptual Salience may be a numerical representation of how clearly a word is pronounced.

Describing an operation of calculating a priority score based on the word level parameter of each word (Step E3), the learning-word extraction program may calculate the priority score for each word included in the first word set by adjusting a weight for each word level parameter through a linear regression algorithm based on a weight criteria or conditions. The weight criteria or conditions may include occurrence frequency, conceptual relevance, and tier systems.

The learning-word extraction program may calculate the priority score by performing a linear regression algorithm based on the mathematical Equation 1 below and the weight criteria.

$$Priority Score s ( {w}_{i} ) = {k}_{f} f ( {w}_{i} ) + {k}_{c} c ( {w}_{i} ) + {k}_{p} p ( {w}_{i} ) \qquad ( Equation 1 )$$

f(wᵢ) represents a frequency value, k_{f} represents the weight for the frequency, c c(wᵢ) represents a commonality value, k_{c} represents the weight for the commonality, p(wᵢ) represents a perceptual salience value, and kₚ represents the weight for the perceptual salience.

Describing an operation of setting the weight for each word-level parameter based on the occurrence frequency among the weight criteria, the criterion for the occurrence frequency is to enable a higher priority score to be calculated for words that the child has not learned among words that occurred relatively more frequently.

The learning-word extraction program may extract a common word simultaneously included in the first word set and the second word set; and while calculating the priority score for each word included in the first word set based on the mathematical Equation 1 above, the weight for each word level parameter may be adjusted so that the common word may be calculated to have a higher priority score than that of other words, and then priority score of each word included in the first word set may be calculated.

Next, describing an operation of setting the weight for each word level parameter based on conceptual relevance among the weight criteria, conceptual relevance is to ensure that words that are conceptually close to words that the child is judged to already know may be calculated with a higher priority score.

For this operation, the learning-word extraction program may extract a/the common word simultaneously included in the first word set and the second word set, and while calculating the priority score for each word included in the first word set based on the mathematical Equation 1 above, the weight for each word level parameter may be adjusted so that a word with high similarity to the common word in the first word set are calculated to have a higher priority score than that of other words, and then the priority score of each word included in the first word set may be calculated. Here, the similarity may be a degree of similarity in meaning.

And, describing an operation of setting the weight for each word level parameter based on the tier system among the weight criteria, the tier system is to enable that a higher priority score is calculated for words with relatively low frequency but higher usability. Here, the usability may indicate how many words may be used as a substitute in multiple contexts included in the conversation data.

For this operation, the learning-word extraction program may calculate the usability for each word included in the first word set based on the conversation data, and the weight for each word level parameter may be adjusted so that a word with at or below a preset frequency but relatively higher usability may be calculated to have a higher priority score than other words—to thereby calculate the priority score for each word included in the first word set. Then, through such operation as above, the priority score for the first word set may be calculated, and the first word set may be organized in descending order (Step E4).

Afterward, the learning-word extraction program may generate the third word set by excluding the second word set from the first word set (Step E5). This is to generate a word set for words that the child has not yet learned by excluding words spoken by the child, i.e., words that the child knows. In addition, the learning-word extraction program may receive a filtering signal for filtering words to be excluded from the third word set, and select “n” number of words from the third word set as the learning words based on the filtering signal. Here, filtering may be filtering out words that the child has learned, such as words that the child has said in other places, or vulgar words such as swear words from the third word set.

The learning-word extraction program may select “n” number of words (where n is a natural number) with the highest priority scores from the third word set as the learning words (Step E6). Additionally, the learning-word extraction program may divide the third word set based on parts-of-speech in Step E6, extract “n” number of words from each part-of-speech group (category), and select them as the learning words.

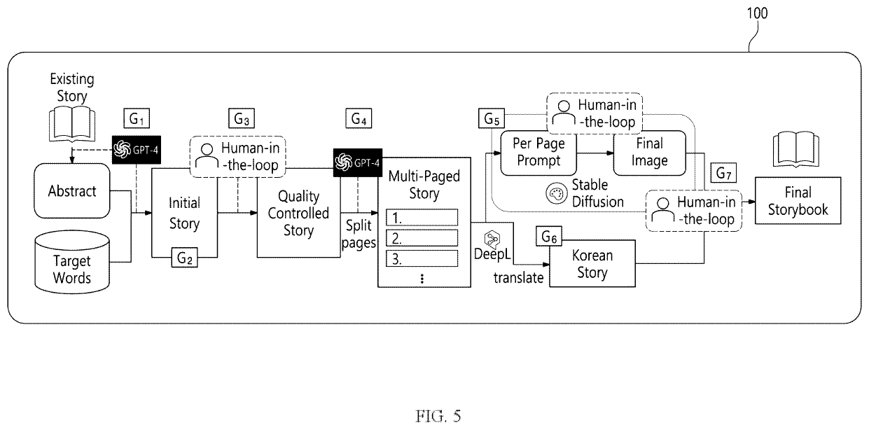

Next, an operation of the learning-word extraction program generating and providing a story by referencing FIG. 5.

The learning-word extraction program may summarize a reference story (Step G1) included in a story dataset into “m” (m is a natural number) number of sentences using a Large Language Model (LLM) in clouds. Reference stories are published stories, for example, the published fairy tales like Aesop's Fables.

The operation of generating the “m” number of summary sentences may be performed by inputting the reference story and summary criteria or conditions into a large language model (LLM) deployed or offered in the clouds, such as GPT, Bard, and LLAMA.

Then, by inputting “m” number of summary sentences and learning words and generation criteria or conditions into the large language model, a learning story that contains the learning words may be generated (Step G2). Step G2 may be performed in a different session from Step G1, and may be performed so that the large language model may not know a use of the reference story.

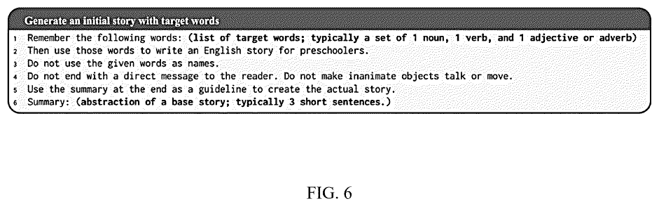

FIG. 6 is an exemplary diagram of an input prompt requesting the generation of the learning story to the large-scale language model (LLM). As shown in FIG. 6, the input prompt may be used to input the learning words, summary sentences, and generation criteria or conditions to generate the learning story through the large-scale language model (LLM).

Then, a reviewing signal for the learning story may be received (Step G3). The review operation may be performed by the manager, and may be an operation to check whether the learning story includes the learning words or is structured according to a story grammar framework. The story grammar framework may comprise or configured in an order/sequence of setting (time, place, character), event start, goal, attempt, result, and response.

Afterward, the learning-word extraction program may input the learning story and the segmentation criteria or conditions into the large-scale language model (LLM), and split or divide the learning story into multiple sentences corresponding to each page (Step G4). Then, in order to generate an image to be inserted into each page, depiction information about characters in the story, the visual characteristics of the characters, and the background may be received, and the depiction information received may be input into an image generation model in the cloud (Step G5) to generate an image for each page. Here, the image generation model may for example, be Stable Diffusion. Further, in Step G4, the image generation model may provide multiple images corresponding to the depiction information input, and may receive a selection signal for (the) multiple images to set images for each page. The operation of selecting an image may be an operation of selecting a most suitable image for each page by an administrator.

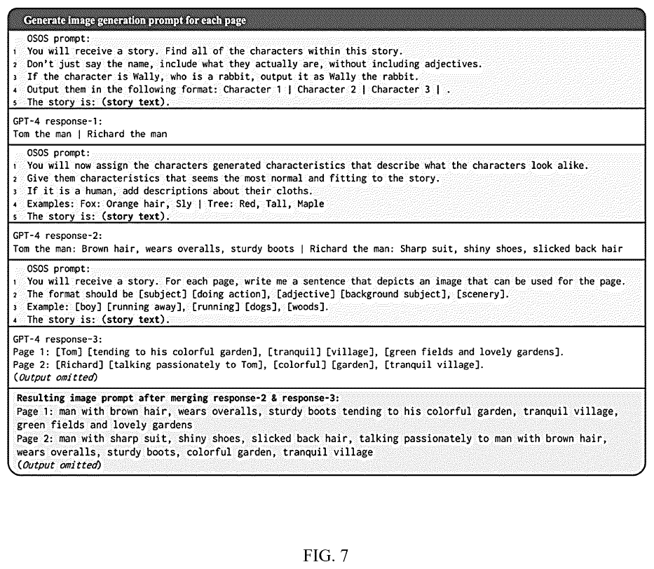

FIG. 7 is an exemplary diagram of a depiction information that is received. As shown in FIG. 7, the depiction information may be received through several steps of inputting a query.

When the contents and images of each page are generated through Step G4 and Step G5, a storybook for the learning story may be generated by combining or synthesizing them (Step G7). Further, an operation of translating the story into a language received before Step G7 (Step G6) may be performed.

In addition, in Step G7, the reviewing signal for the learning story that is translated into a predetermined language may be received, and a storybook for the learning story may be provided to the user terminal (200) based on thereon. Here, the review operation may be an operation in which the administrator reviews whether the learning story has been naturally translated into the predetermined language.

The learning-word extraction program may generate the learning story that contains the learning words and the image(s) for the learning story by performing Step G1 through Step G7, and may generate a storybook that combines or synthesizes the learning story and the image(s) and provide it to the user terminal (200).

Meanwhile, the processor (120) may perform hardware control functions such as a file system, memory allocation, network, basic library, timer, device control (display, media, input device, 3D, etc.), and other utilities needed when executing a program. In the present embodiment, the processor (120) may be implemented in a form of a microprocessor, a central processing unit (CPU), a processor core, a multiprocessor, an application-specific integrated circuit (ASIC), a field programmable gate array (FPGA), etc., but the scope of the present invention is not limited thereto.

In addition, a communication module (130) may comprise a device, including hardware and software required to transmit and receive signals, such as control signals or data signals, through wired or wireless connections with other network devices in order to perform data communication with external devices and signal data. A database (140) may store various data for the operation of the learning-word extraction program.

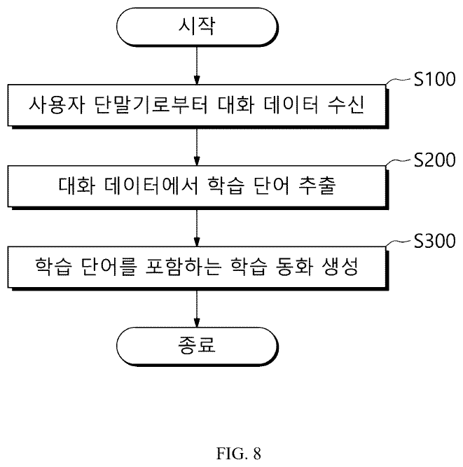

FIG. 8 is a flowchart for explaining a learning-word extraction method according to an embodiment of the present invention.

A learning-word extraction method is described by referencing FIG. 1, FIG. 3, and FIG. 8. In the learning-word extraction method, a child's conversation data may be received from the user terminal (200) (Step S100), and learning words to be taught to the child from may be extracted from the conversation data (Step S200). Then, for learning the learning words, the learning story may be created using the learning words and the learning story may be provided to the user terminal (200) (Step S300).

Next, each step in the learning-word extraction method is described in detail.

First, the step (S100) of receiving the child's conversation data is described. The learning-word extraction device (100) may receive the child's conversation data recorded through at least one of the first recorder (10) and the second recorder (20) from the user terminal (200). Here, the child's conversation data may be the conversation(al) content between the child and a caregiver such as the parent.

In addition, the first recorder (10) may be a type of recorder, such as a necklace or watch, that may be worn by the child or the caregiver and may record the voice of the child or the caregiver from a close range and intensively record the voice of the child or caregiver even when the child and caregiver are conversing while moving. The second recorder (20) may be a recorder fixed to a predetermined location and may record an entire conversation. The conversation data can include a first conversation data recorded by the first recorder (10) and a second conversation data recorded by the second recorder (20). In the first conversation data, the child's or caregiver's speech or utterance may primarily be recorded, and in the second conversation data, the conversation between the child and caregiver may primarily be recorded.

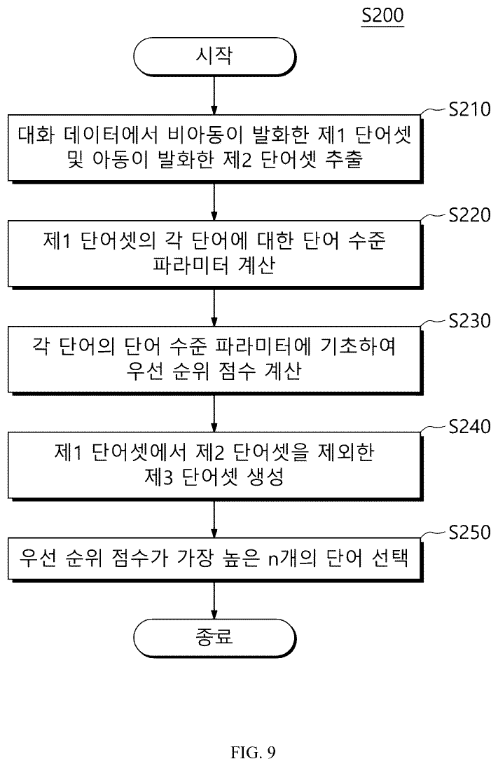

Next, the step (S200) of the learning-word extraction device (100) extracting the learning word from the conversation data is described with reference to FIG. 4 and FIG. 9.

First, the learning-word extraction device (100) converts the conversation data in voice format received from the user terminal (200) into a conversation script to distinguish between the non-child speaker and the child speaker. Then, based on the conversation script, the first word set, which is the words spoken by the non-child speaker, and the second word set, which is the words spoken by the child speaker (S210), may be generated. Here, the non-child speaker may be a caregiver such as the parent.

In the step (S210, Step E1) of generating the first word set and the second word set, the learning-word extraction device (100) may remove stop words, which are words that cannot be used. In the process of removing the stop words, tags for the part-of-speech of each word may be set, and stop words may be selected based on the part-of-speech tags. In addition, if there are multiple identical roots with different suffixes, the learning-word extraction device (100) may perform an operation of keeping only one and removing the rest.

Next, the step (S220, Step E2) of calculating word level parameters for each word included in the first word set is described.

The learning-word extraction device (100) may calculate the word level parameters of each word included in the first word set, based on the conversation data. The word level parameters may include at least one of frequency, commonality, and perceptual salience. Frequency may be a numerical representation of the number of times a word appears in the conversation data. Commonality may be a numerical representation of how many contexts a word commonly appears in. And Perceptual Salience may be a numerical representation of how clearly a word is pronounced.

Describing the step (S230, Step E3) of calculating a priority score based on the word level parameter of each word (Step E3), the learning-word extraction device (100) may calculate the priority score for each word included in the first word set by adjusting a weight for each word level parameter through a linear regression algorithm based on a weight criteria or conditions. The weight criteria or conditions may include occurrence frequency, conceptual relevance, and tier systems.

The learning-word extraction program may calculate the priority score by performing a linear regression algorithm based on the mathematical Equation 1 below and the weight criteria.

$$Priority Score s ( {w}_{i} ) = {k}_{f} f ( {w}_{i} ) + {k}_{c} c ( {w}_{i} ) + {k}_{p} p ( {w}_{i} ) \qquad ( Equation 1 )$$

f(wᵢ) represents a frequency value, k_{f} represents the weight for the frequency, c c(wᵢ) represents a commonality value, k_{c} represents the weight for the commonality, p(wᵢ) represents a perceptual salience value, and kₚ represents the weight for the perceptual salience.

Next, an operation of calculating the priority score according to each of the weight criteria is described.

First, describing an operation of setting the weight for each word-level parameter based on the occurrence frequency among the weight criteria, the criterion for the occurrence frequency is to enable a higher priority score to be calculated for words that the child has not learned among words that occurred relatively more frequently.

The learning-word extraction device (100) may extract a common word included simultaneously in the first word set and the second word set; and while calculating the priority score for each word included in the first word set based on the mathematical Equation 1 above, the weight for each word level parameter may be adjusted so that the common word may be calculated to have a higher priority score than that of other words, and then priority score of each word included in the first word set may be calculated.

Next, describing an operation of setting the weight for each word level parameter based on conceptual relevance among the weight criteria, conceptual relevance is to ensure that words that are conceptually close to words that the child is judged to already know may be calculated with a higher priority score.

the learning-word extraction device (100) may extract a/the common word included in both the first word set and the second word set (simultaneously), and while calculating the priority score for each word included in the first word set based on the mathematical Equation 1 above, the weight for each word level parameter may be adjusted so that a word with high similarity to the common word in the first word set are calculated to have a higher priority score than that of other words, and then the priority score of each word included in the first word set may be calculated. Here, the similarity may be a degree of similarity in meaning.

Lastly, describing an operation of setting the weight for each word level parameter based on the tier system among the weight criteria, the tier system is to enable that a higher priority score is calculated for words with relatively low frequency but higher usability. Here, the usability may indicate how many words may be used as a substitute in multiple contexts included in the conversation data.

The learning-word extraction device (100) may calculate the usability for each word included in the first word set based on the conversation data, and the weight for each word level parameter may be adjusted so that a word with at or below a preset frequency but relatively higher usability may be calculated to have a higher priority score than other words—to thereby calculate the priority score for each word included in the first word set. Then, through such operation as above, the priority score for the first word set may be calculated, and the first word set may be organized in descending order (Step E4).

Afterward, the learning-word extraction device (100) may generate the third word set by excluding the second word set from the first word set (S240, Step E5). This is to generate a word set for words that the child has not yet learned by excluding words spoken by the child, i.e., words that the child knows. In addition, in S240, the learning-word extraction device (100) may receive a filtering signal for filtering words to be excluded from the third word set, and select “n” number of words from the third word set as the learning words based on the filtering signal. Here, filtering may be filtering out words that the child has learned, such as words that the child has said in other places, or vulgar words such as swear words from the third word set.

Afterward, the learning-word extraction device (100) may select “n” number of words (where n is a natural number) with the highest priority scores from the third word set as the learning words (S250, Step E6).

Additionally, the learning-word extraction device (100) may divide the third word set based on parts-of-speech in S250, extract “n” number of words from each part-of-speech group (category), and select them as the learning words.

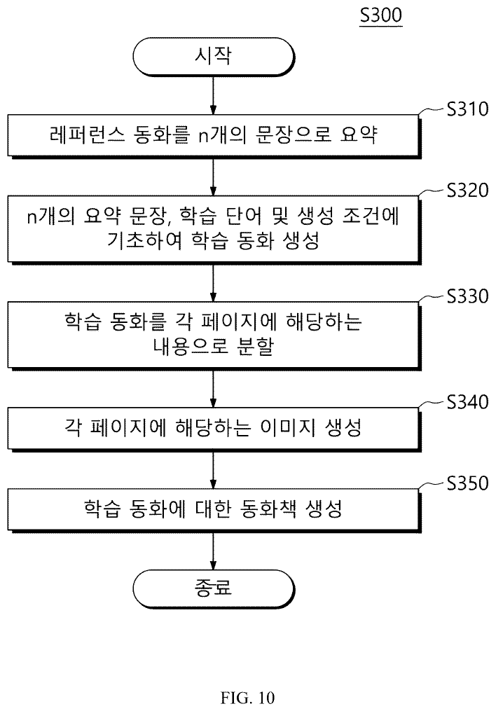

Next, a process of the learning-word extraction program generating and providing a story (S300) is described by referencing FIG. 5 and FIG. 10.

The learning-word extraction device (100) may summarize a reference story (Step G1) included in a story dataset into “m” (m is a natural number) number of sentences using a Large Language Model (LLM) in clouds. Reference stories are published stories, for example, the published fairy tales like Aesop's Fables.

The process of generating the “m” number of summary sentences may be performed by inputting the reference story and summary criteria or conditions into a large language model (LLM) deployed or offered in the clouds, such as GPT, Bard, and LLAMA.

Then, by inputting “m” number of summary sentences and learning words and generation criteria or conditions into the large language model, a learning story that contains the learning words may be generated (S320, Step G2). Step G2 may be performed in a different session from Step G1, and may be performed so that the large language model may not know a use of the reference story.

FIG. 6 is an exemplary diagram of an input prompt requesting the generation of the learning story to the large-scale language model (LLM). As shown in FIG. 6, the input prompt may be used to input the learning words, summary sentences, and generation criteria or conditions to generate the learning story through the large-scale language model (LLM).

And, in S320, the learning-word extraction device (100) may receive a reviewing signal for the learning story (Step G3). The review operation may be performed by the manager, and may be an operation to check whether the learning story includes the learning words or is structured according to a story grammar framework. The story grammar framework may comprise or configured in an order/sequence of setting (time, place, character), event start, goal, attempt, result, and response.

Afterward, the learning-word extraction device (100) may input the learning story and the segmentation criteria or conditions into the large-scale language model (LLM), and split or divide the learning story into multiple sentences corresponding to each page (S330, Step G4). Then, in order to generate an image to be inserted into each page, depiction information about characters in the story, the visual characteristics of the characters, and the background may be received, and the depiction information received may be input into an image generation model in the cloud (S340, Step G5) to generate an image for each page. Here, the image generation model may for example, be Stable Diffusion. Further, in S340, the image generation model may provide multiple images corresponding to the depiction information input, and may receive a selection signal for (the) multiple images to set images for each page. The operation of selecting an image may be an operation of selecting a most suitable image for each page by an administrator. FIG. 7 is an exemplary diagram of a depiction information that is received. As shown in FIG. 7, the depiction information may be received through several steps of inputting a query.

When contents and images corresponding to each page are generated through S330 and S340, a storybook for the learning story may be generated by combining or synthesizing them (S350, Step G7). Further, in S350, the learning-word extraction device (100) may perform an operation of translating the story into a language received before Step G7 (Step G6).

In addition, in Step G7, the learning-word extraction device (100) may receive the reviewing signal for the learning story that is translated into a predetermined language may be received, and a storybook for the learning story may be provided to the user terminal (200) based on thereon. Here, the review operation may be an operation in which the administrator reviews whether the learning story has been naturally translated into the predetermined language, and the reviewing signal may include information as to interpretation edits.

The learning-word extraction device (100) may generate the learning story that contains the learning words and the image(s) for the learning, and may generate a storybook that combines or synthesizes the learning story and the image(s) and provide it to the user terminal (200).

The above description is merely an illustrative description of the technical spirit of the present embodiments, and those with ordinary skill in the art to which the present embodiments belongs may make various modifications and variations without departing from the essential characteristics and features of the present embodiments. Therefore, the present embodiments are not intended to limit the technical spirit of the present embodiments, but to explain them, and the scope of the technical spirit of the present embodiments is not limited by these embodiments. The technical scope of the present embodiments should be interpreted by the following claims, and all technical spirits, concept and ideas within a scope equivalent thereto should be interpreted as being included in the technical scope of and the scope of rights in the present embodiments of the present invention.

### REFERENCE NUMERALS

100: Device for Extracting Learning Words
110: Memory
120: Processor

1. A learning-word extraction device comprising:
a memory storing a learning word extraction program that extracts learning words to be taught to a child based on the child's conversation content, and
a processor executing the learning word extraction program;
wherein the learning word extraction program receives a conversation data, extracts a first word set uttered by the non-child and a second word set uttered by the child from the conversation data, generates a third word set by excluding the second word set from the first word set, and selects the learning words to be taught to the child from the third word set, based on a selection criteria.

2. The learning-word extraction device according to claim 1, wherein
the learning word extraction program calculates a word-level parameter for each word included in the first word set, and calculates a priority score based on the word-level parameter;
wherein the word level parameter includes at least one of:
a frequency indicating a number of times the word appears,
a commonality indicating how many contexts the word commonly appears in, and
a perceptual salience indicating how clearly the word is pronounced.

3. The learning-word extraction device according to claim 2, wherein the learning word extraction program calculates the priority score for each word by adjusting a weight for each word-level parameter by performing a linear regression algorithm based on a weight criteria.

4. The learning-word extraction device according to claim 3, wherein the learning word extraction program
extracts common words that are simultaneously included in the first word set and the second word set, and
calculates the priority score for the first word set by adjusting the weights for the word-level parameters of the words through the linear regression algorithm so that the common words in the first word set are calculated to have the priority score higher than that of the other words.

5. The learning-word extraction device according to claim 3, wherein the learning word extraction program
extracts common words that are simultaneously included in the first word set and the second word set, and
adjusts the weight for each word-level parameter through the linear regression algorithm so that words having a high similarity to the common words in the first word set are calculated to have the priority score higher than that of the other words
and then calculates the priority score for the first word set.

6. The learning-word extraction device according to claim 3, wherein
the learning word extraction program
calculates a usability for each word included in the first word set, and
calculates the priority score for the first word set while adjusting the weight for each word-level parameter through the linear regression algorithm so that the word that has a predetermined frequency or lower than the predetermined frequency but a relatively higher usability, is calculated to have a higher priority score than that of the other words;
wherein the usability indicates how many words can be as replacements in a context.

7. The learning-word extraction device according to claim 4,
the learning word extraction program generates the third word set by excluding the second word set from the first word set, and select n-number of words with a highest priority score from the third word set as the learning words; wherein n is a natural number.

8. The learning-word extraction device according to claim 5, wherein
the learning word extraction program receives a filtering signal for filtering words to be excluded from the third word set, and selects n-number of words from the third word set as the learning words based on the filtering signal.

9. The learning-word extraction device according to claim 5, wherein
the learning word extraction program divides the third word set based on parts of speech, and extract at least one word from each part of speech group to select as the learning word.

10. The learning-word extraction device according to claim 1, wherein
the learning word extraction program generates and provide a story that contains the learning word so that the learning word are taught or learned.

11. The learning-word extraction device according to claim 10, wherein
the learning word extraction program
summarizes a reference story that is included in a story dataset into m-number of sentences, and
generate a story for learning based on the m-number of sentences, the learning words, and a story generation criteria.

12. A learning word extraction method comprising:
a step of receiving a conversation data;
a step of extracting a first word set uttered by a non-child and a second word set uttered by a child, from the conversation data;
a step of generating a third word set, by excluding the second word set from the first word set; and
a step of selecting learning words to be taught to the child from the third word set, based on a selection criteria included in the third word set.

13. The learning word extraction method according to claim 12, wherein
the step of generating the third word set comprises:
calculating a word-level parameter for each word included in the first word set, and
calculating a priority score based on the word-level parameter;
wherein the word-level parameter includes at least one of:
a frequency indicating a number of times a word appears,
a commonality indicating how many different contexts a word commonly appears in, and
a perceptual salience indicating how clearly a word is pronounced.

14. The learning word extraction method according to claim 13, wherein
the step of generating the third word set further comprises:
calculating the priority score for each word by adjusting a weight for each word-level parameter, by performing a linear regression algorithm based on a weight criteria.

15. The learning word extraction method according to claim 14, wherein
the step of generating the third word set further comprises:
extracting common words simultaneously included in the first word set and the second word set, and
calculating the priority score for the first word set by adjusting the weights for the word-level parameters of the words through the linear regression algorithm so that the common words in the first word set are calculated to have a higher priority score than that of the other words.

16. The learning word extraction method according to claim 14, wherein
the step of generating the third word set further comprises:
extracting common words included in both the first word set and the second word set, and
calculating the priority score for the first word set by adjusting the weight for each word-level parameter through the linear regression algorithm so that a word having a high similarity to the common word in the first word set is calculated to have a higher priority score than that of the other words.

17. The learning word extraction method according to claim 14, wherein
the step of generating the third word set further comprises:
calculating the usability for each word included in the first word set, and
calculating the priority score for the first word set by adjusting the weight for each word-level parameter through the linear regression algorithm so that a word having a predetermined frequency or lower than the predetermined frequency while having relatively higher usability is calculated to have a higher priority score than that of other words;
wherein the usability indicates how many words a given word may be used to replace the words in a given context.

18. The learning word extraction method according to claim 12, wherein
the step of selecting the learning words comprises:
selecting n-number of words having the highest priority scores from the third word set as the learning words, wherein n is a natural number.

19. The learning word extraction method according to claim 12, wherein
the step of selecting the learning words comprises:
receiving a filtering signal for filtering words to be excluded from the third word set, and
selecting n-number of words from the third word set as the learning words based on the filtering signal.

20. The learning word extraction method according to claim 18, wherein
the step of selecting the learning words comprises:
dividing the third word set based on parts of speech,
extracting at least one word from each part-of-speech group, and
selecting the at least one word as the learning words.

21. The learning word extraction method according to claim 12, further comprising:
a step of generating a story that contains the learning words so that the learning words are learned.

22. The learning word extraction method according to claim 21, wherein
the step of generating the story that contains the learning words comprises:
summarizing a reference story that is included in a story dataset into m-number of sentences, and
generating a learning story or a story for learning, based on the m-number of sentences, the learning words, and a story generation criteria;
wherein m is a natural number.
